(19) United States
(12) Patent Application Publication
(10) Pub. No.: US 2009/0322628 A1
(43) Pub. Date: Dec. 31, 2009

(54) ANTENNA ENCLOSURE

(76) Inventors: Yukon J. Palmer, San Diego, CA (US); William Holmes, San Diego, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/430,749

(22) Filed: Apr. 27, 2009

Related U.S. Application Data
(60) Provisional application No. 61/048,143, filed on Apr. 25, 2008.

(51) Int. Cl. H01Q 1/24

(52) U.S. Cl. 343/702

(57) ABSTRACT

Methods and apparatus for an antenna enclosure. An enclosure through which satellite signals from satellite positioning services may be received may include an antenna to receive the satellite signals and relay the signals to a receiver, and the enclosure may be coupled to a device to disguise the enclosure as a component of construction equipment. The enclosure may include a receiver device to process received satellite signals. The device may be a work light. The enclosure may include mounting hardware to mount the enclosure to a construction vehicle, such as an excavator, articulated truck, compact track loader, compaction equipment, crawler dozer, forklift, loader/backhoe, loader/tool carrier, motor grader, skid steer loader, telescopic handler, or wheel loader.

### RELATED APPLICATION

This application claims priority to U.S. Pat. App. Ser. No. 61/048,143 filed on Apr. 25, 2008, the contents of which are hereby fully incorporated by reference.

### BACKGROUND

Assets, such as construction equipment are increasingly being tracked and monitored using GPS tracking devices. Theft, or disablement of such GPS tracking devices when the assets are in remote locations, or on sites that are not always secure, is an increasingly expensive problem.

### SUMMARY

The subject matter disclosed herein provides methods and apparatus that implement techniques related to an antenna enclosure.

In a first aspect, an enclosure and a device are provided. Satellite signals from satellite positioning services are received through the enclosure. The enclosure includes an antenna to receive the satellite signals and relay the signals to a receiver. The device is coupled to the enclosure where the device is to disguise the enclosure as a component of construction equipment is provided.

In a second interrelated aspect, a base and a top portion are provided. The base has a first plurality of openings around a circumference for affixing the base to a mounting surface (e.g., construction equipment, etc.) and a second plurality of openings. The base also includes a mounting portion on which a GPS unit having at least one antenna can be mounted. The top portion covers the base so that the GPS unit is not visible when coupled to the base. The top portion comprises a third plurality of openings for affixing the top portion to the base via the second plurality of openings as well as an outwardly extending opaque element positioned substantially over the GPS unit when the top portion is affixed to the base.

Variations may include one or more of the following features. An enclosure may include a receiver device to process received satellite signals. A device coupled to an enclosure may be a work light. An enclosure may be disguised to appear as part of the light housing and not a separate component. An enclosure may include mounting hardware to mount the enclosure to a construction vehicle, such as an excavator, articulated truck, compact track loader, compaction equipment, crawler dozer, forklift, loader/backhoe, loader/tool carrier, motor grader, skid steer loader, telescopic handler, or wheel loader.

The subject matter described herein can be implemented to realize one or more of the following advantages. A satellite receiver antenna may be enclosed in an enclosure that serves as a decoy of another feature of construction equipment and does not appear as a satellite receiver antenna. For example, a satellite receiver antenna may be enclosed in an enclosure that includes a work light. Such a device may be less likely to be tampered with by a machine's operator or a potential thief due to its misleading appearance. As a consequence, the misleading appearance may aid an owner in recovering the equipment if it is stolen as the satellite antenna may continue to operate. Also, as the device may be mounted to an exterior surface of a construction vehicle (or other equipment), reception of satellite signals might not be interfered by the vehicle (e.g., if a vehicle has a thick metal roof that interferes with reception). In vehicles where a roof or other surface of construction equipment does not interfere with reception, an antenna enclosure may be mounted inside the equipment and be disguised as a component of the construction equipment.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a diagram of a satellite positioning system.

FIG. 2 is a block diagram of an antenna enclosure device.

FIGS. 3A-3B are block diagrams of antenna enclosure devices.

FIG. 4A is a diagram of two components of an antenna enclosure device displayed separately.

FIG. 4B is a diagram of the two components of the antenna enclosure device of FIG. 4A affixed to each other.

Like reference numbers and designations in the various drawings indicate like elements.

### DETAILED DESCRIPTION

Satellite tracking devices require an antenna that has line of sight with satellite networks such as the Global Positioning System (GPS), the Global Navigation Satellite System (GLONASS), and the Galileo satellite positioning system to determine a receiver device's latitude, longitude, velocity, and altitude. The antennas that receive satellite signals typically require an unobstructed view of the sky to receive the signals. Satellite positioning receivers may require reception of signals from at least two satellites in order to determine one or more locations of the receivers.

Information from a satellite positioning receiver may be transmitted from the receiver over a network, such as a wireless network, to a server to display the location of the receiver to an end user.

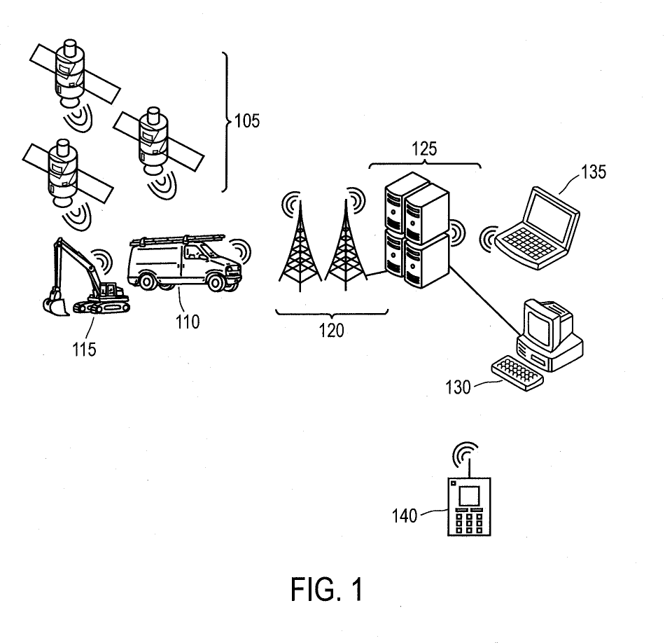

FIG. 1 is a diagram of a satellite positioning system. In FIG. 1, the satellites 105 send signals that may be received by a receiver on each of a van 110 and an excavator 115. Each receiver may receive signals from at least two satellites at once to determine a position. That information may be sent wirelessly (e.g., over a CDMA (code-division multiple access) or GSM (Global System for Mobile communications) link; low-earth orbiting satellites; WiMax (e.g., Institute of Electrical and Electronics Engineers (IEEE) 802.16 standard), WiFi (Wireless Fidelity; e.g., according to the IEEE 802.11 (g) standard), Zigbee (e.g., according to IEEE 802.15.4); 2.5 Ghz, 900 Mhz, or other wireless networks) from each of the van 110 and excavator 115 to the towers 120, which may relay that information to the servers 125 that may process the information. The servers 125 may be part of a communication network run by a mobile network operator (e.g., VERIZON), may be part of a location based service separate from a mobile network operator, or may be part of another affiliation. The servers 125 may communicate with end user devices, such as the laptop 135, personal computer 130, or mobile handset device 140, to relay location based information derived from the positioning information sent by the van 110 and excavator 115 (e.g., the servers 125 may be web servers that include web-based applications for processing the positioning information and overlay it on a map with other information that may be useful to an end-user (e.g., a name of a vehicle associated with positioning information)).

Since antennas of receivers may require a line of sight with the satellites to aid in determining their locations, mounting the antennas underneath metal or fiberglass (e.g., heavy or thick proportions of these materials that may be part of a frame of a construction vehicle) may be undesirable because these materials may obstruct signals from the satellites. Thus, while antennas may be hidden underneath a dashboard of a car, truck or van, they might not be easily hidden when installed in construction equipment. A monitoring unit installed in construction equipment may have an external antenna that is mounted on the exterior of the equipment to receive satellite signals such that there is a strong signal, if any. External mounting may be required because the equipment is made of steel or another dense metal that would not allow the satellite signals to travel into an interior location of construction equipment (e.g., construction vehicles such as an excavator). Since an antenna may be exposed on an exterior of the equipment, it might not be easily concealed and a potential thief may easily determine that it is used to monitor the location of the equipment. Such a thief may easily disconnect or cut the wires to the satellite receiver antenna rendering the device unable to determine its location to aid in theft recovery.

An enclosure for a satellite receiver antenna may appear as a standard emergency light or another standard feature of construction equipment to address issues related to an antenna that might be otherwise easily recognizable as a satellite receiver antenna. The enclosure may house the satellite receiver antenna and may further house the receiver. The enclosure may be a weather resistant box with a functional light mounted on top of it. The enclosure may be mounted on the exterior of the construction equipment and appear to be a standard work light (e.g., a standard emergency light, such as a rotating yellow light that may be used when construction equipment is in use, or as a light used to assist visibility). The enclosure may be part of a non-functional (e.g., non-functional in the sense that light is not emitted but may be functional in the sense of being a decoy), “dummy” work light and the satellite antenna, receiver, or both may be mounted within the non-functional, “dummy” light. A device that appears as a standard light may be less likely to be tampered with by a machine's operator or a potential thief. This may aid an owner in recovering the equipment if it is stolen. In other variations, a functional lighting device is also incorporated into the enclosure.

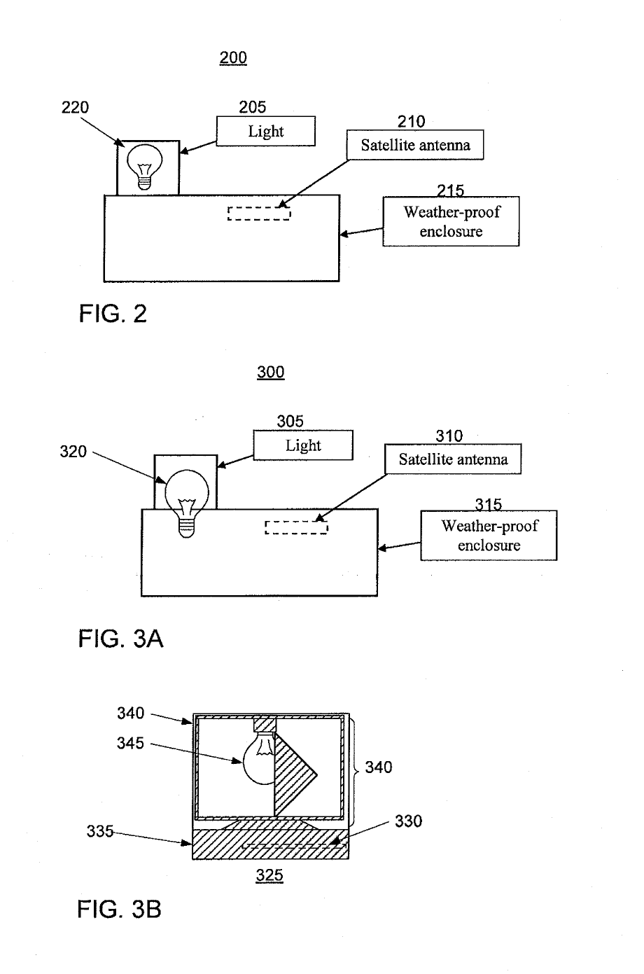

FIG. 2 is a block diagram of an antenna enclosure device 200. The antenna enclosure device 200 includes a light fixture 205, a satellite antenna 210, and a weatherproof enclosure 215. In general, operation of the device 200 may be as follows. Positioning satellites may constantly send signals to Earth. The device 200 mounted on or in a vehicle or other construction equipment may receive these signals (through the satellite antenna 210 that is located within the enclosure 215) and uses them to determine latitude, longitude, altitude and velocity of the device 200 (e.g., with the use of a receiver device located within the enclosure 215 or located outside the enclosure 215 (e.g., the antenna 210 may relay signals to receiver hardware within a vehicle that may process the signals)). The device 200 may then transmit latitude, longitude, altitude, velocity, and other data over a wireless network (e.g., CDMA, GSM, WIMAX (World Interoperability for Microwave Access), or a wireless network using another technology) to a processing server (e.g., one of the servers 125 of FIG. 1). The incoming information may then be processed and stored on computer servers (e.g., the servers 125) or directly on an end user's server or personal computer (e.g., the laptop 135, personal computer 130, handset 140, all three types of devices, or another device). A user may log into a web site or open a system's software program to view the current and past locations and activities of the vehicles and equipment (e.g., through the laptop 135, personal computer 130, handset 140, all three types of devices, or another device).

The enclosure 215 may be made of heavy grade plastic materials and may also consist of rubber, poly vinyl chloride, and many other non-metal materials. A key characteristic of the enclosure 215 is that radio frequencies sent by positioning satellites can penetrate its exterior (and be receivable by the antenna 210).

Although the enclosure 215 is shown as including the satellite antenna 210, they may further include one or more of the following: a wireless transmission antenna (e.g., for communicating with the servers 125 over a wireless network); a satellite signal micro-controller (e.g., a receiver device to process incoming satellite signals to determine longitude, latitude, altitude, and velocity); a wireless modem; and a printed circuit board. The satellite signal micro-controller processes the location satellite signals to assist in determining the device's location. The wireless modem may allow the device to send and receive data and commands over a wireless network. Each component may reside on a printed circuit board, which may manage how the device 200 interacts with each component and its power supply. The enclosure 215 may also include a small battery to provide power to the device. The enclosure 215 may also house the positioning satellite receiver antenna with or without one or more components of a tracking device (e.g., further hardware may be required for tracking, such as a storage device to log positions or further hardware to assist with dead-reckoning).

Although the enclosure 215 is weatherproof, in variations it need not be. In addition, in variations the enclosure 215 may be tamper-proof. For example, it might be formed using security screws such that a normal screwdriver is not capable of opening the enclosure 215. Also, although the enclosure 215 is shaped as a rectangular box, the enclosure 215 may be of another shape. A shape of the enclosure 215 may mimic a typical enclosure that accompanies a work light for construction equipment (e.g., having the same dimensions, amount of sides, and angles).

The satellite reception antenna 210 is inside the enclosure 215 and may be positioned in an area adjacent to the light fixture 205. The antenna 210 may be placed facing the top surface or one of the side surfaces of the enclosure.

The light fixture 205 may mask the device 200 and may be incorporate different types of lights, including halogen spot lights, florescent lights, other gas tube lights and strobe type lights. The light may be placed on top of the enclosure or on one of the sides of the enclosure. It may be placed in a location not to obstruct the signals sent to the satellite receiver antenna. The light fixture 205 may be attached to the enclosure 215 using a heavy grade glue, Velcro-type material, a bolt/screw connection, by using welding, rivets, or other mechanisms, techniques, or both.

The enclosure 215 may be mounted on an exterior surface of a vehicle or other construction equipment. It may be mounted using Velcro-type materials, double sided tape, or a heavy duty glue or other adhesive. It may also be mounted using brackets attached to the enclosure and the body of the vehicle or construction equipment. Other types of mounting mechanism, techniques, or both may be used.

The enclosure may be composed of a type of material designed to allow painting to match one or more colors of construction equipment or vehicles that it is attached to. It may also be composed of material that is not easily painted.

The device 200 may be powered by the vehicle or construction equipment's battery, or may have its own dedicated battery to be used as a power supply. A dedicated battery may be housed inside or outside of the enclosure 215. If using a vehicle or construction equipment's battery supply, the electrical wiring for the device may be required to run from the enclosure to the vehicle or construction equipment for power. It may also run to an ignition power cable to determine when the engine of the vehicle or construction equipment is turned on and off. It may also be required to have a wire run to the chassis of the vehicle or construction equipment for a ground connection. The wires may extrude from the top, bottom, or side of the enclosure to be run to the appropriate connection in the vehicle or construction equipment.

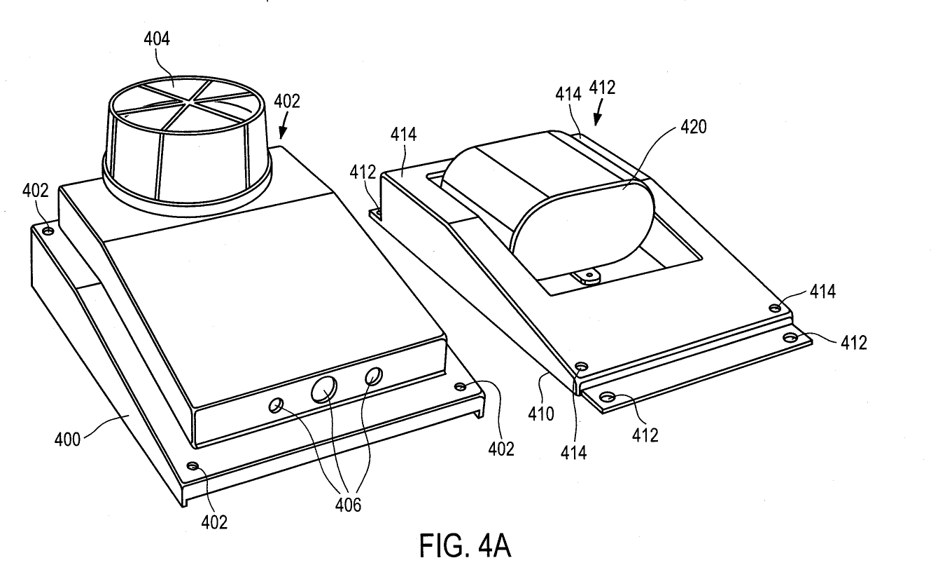

FIGS. 3A-3B are block diagrams of antenna enclosure devices. The device 300 of FIG. 3A is similar to the device 200 of FIG. 2 with an exception being that the light bulb 320 as part of the light fixture 305 is situated part-way inside the enclosure 300 whereas the light bulb 220 is situated wholly within the light fixture 205. The incorporation of the light bulb 320 within the enclosure 315 may assist in disguising the device 300 as not including an antenna.

The device 325 of FIG. 3B is a rotating emergency light that incorporates a satellite receiver antenna 330. The satellite antenna 330 is housed inside the base 335, which may further include a motor for rotating the light bulb rotating assembly 340. The light bulb rotating assembly 340 is located inside the lens 345 and the rotating assembly 340 includes the light bulb 345. As with the incorporation of the antenna 310 into the enclosure 315 for the antenna 310 in the device 300, the incorporation of the antenna 330 into a typical component of a light may assist with disguising the device 325 as not including an antenna.

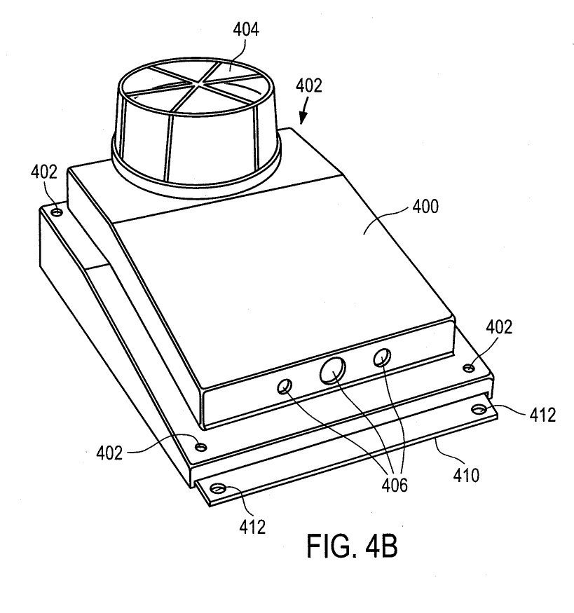

FIG. 4A is a diagram of two components of an antenna enclosure device displayed separately (a top portion 400 and a base 410) and FIG. 4B is a diagram of the top portion 400 affixed to the base 410. The base 410 can include a first plurality of openings 412 around a circumference for affixing the base to construction equipment and a second plurality of openings 414. The base 410 can further include a mounting portion on which a GPS unit 420 having at least one antenna 422 coupled thereto is mounted. The top portion 400 is configured to cover the base 410 so that the GPS unit 420 and the antenna 422 are not visible. The top portion 400 can include a third plurality of openings 402 for affixing the top portion to the base 410 via the second plurality of openings 414. The top portion 400 can further include an outwardly extending opaque element 404 positioned substantially over the GPS unit 420 when the top portion is affixed to the base 410. The opaque element 404 can be positioned to allow satellite signals from GPS satellites to be received by the antenna 422 coupled to the GPS unit 420.

The opaque element 404 can be cylindrical. At least one of the base 410 and the top portion 400 can be manufactured from a material through which the satellite signals from GPS satellites cannot propagate. The top portion 400 can completely cover the base 410 when affixed thereto. One or more of the top portion 400 and the base 410 can include a light element (not shown) positioned to emit light through the opaque element 404. The top portion 400 can also include one or more ports 406 to allow for electrical connections to devices enclosed by the antenna enclosure device including the GPS unit 420.

In implementations, technologies other than, or in addition to, GPS may be used to determine a location. For example, triangulation of cellular towers or other techniques may be used to determine location in the absence of a true GPS fix. As another example, with Assisted GPS, a fix may be attempted from satellites, and (if line of sight doesn't exist) then attempted from several other calculations to determine approximate location. An A-GPS receiver may use an assistance server, where the assistance server may locate a device operating off mobile networks (e.g., an antenna that is in an enclosure and operates over cellular networks) roughly by what cell site it is connected to on the cellular network. An assistance server may have a good satellite signal, and lots of computation power, so it can compare fragmentary signals relayed to it by devices, with the satellite signal it receives directly, and then inform the device or emergency (e.g., theft recovery) services of the device's position. The server may supply orbital data for the GPS satellites to the device, enabling the device to lock to the satellites when it otherwise could not, and autonomously calculate its position. The server may also have better knowledge of ionospheric conditions and other errors affecting the GPS signal than the device alone, enabling more precise calculation of position. Some A-GPS solutions may require an active connection to a cellular (or other data) network to function, in others it may make positioning faster and more accurate, but is not required. As an additional benefit, A-GPS may reduce both the amount of CPU and programming required for a GPS device by offloading most of the work onto the assistance server.

In implementations, other construction-related equipment may be used as a disguise for an antenna enclosure. For example, reflector lights (that do not use bulbs) may be also be used on an antenna enclosure.

The subject matter described herein has been described in terms of particular embodiments, but other embodiments can be implemented and are within the scope of the following claims. For example, operations can differ and still achieve desirable results. Other embodiments are within the scope of the following claims

1. An apparatus comprising:
an enclosure through which satellite signals from satellite positioning services are received, the enclosure comprising:
an antenna to receive the satellite signals and relay the signals to a receiver; and
a device coupled to the enclosure, the device to disguise the enclosure as a component of construction equipment.

2. An apparatus in accordance with the apparatus of claim 1, wherein the enclosure further comprises a receiver device to process received satellite signals.

3. An apparatus in accordance with the apparatus of claim 2, wherein the receiver comprises a wireless modem to connect to a wireless network.

4. An apparatus in accordance with the apparatus of claim 1, wherein the enclosure is made of a material that allows satellite signals to pass through.

5. An apparatus in accordance with the apparatus of claim 1, wherein the material is plastic.

6. An apparatus in accordance with the apparatus of claim 1, wherein the device comprises a light physically connected to the enclosure and the enclosure is disguised to appear as part of the light housing and not a separate component.

7. An apparatus in accordance with the apparatus of claim 1, wherein the light is electrically connected to a device inside the enclosure.

8. An apparatus in accordance with the apparatus of claim 1, wherein the light is electrically connected to a vehicle independent of the device.

9. An apparatus in accordance with the apparatus of claim 1, wherein the enclosure further comprises is a printed circuit board.

10. An apparatus in accordance with the apparatus of claim 1, wherein the apparatus further comprises mounting hardware for mounting the device to a construction vehicle.

11. An apparatus in accordance with the apparatus of claim 10, wherein the construction vehicle has a roof with a material of a quality that interferes with reception of the antenna were the antenna to be located under the roof such that satellite signals from at least one satellite would not be receivable.

12. An apparatus in accordance with the apparatus of claim 1, wherein the enclosure further includes a storage device to store location information of the apparatus.

13. An apparatus comprising:
an enclosure through which satellite signals from satellite positioning services are received, the enclosure comprising:
a first device to receive the satellite signals from an antenna; and
a second device coupled to the enclosure, the second device to disguise the enclosure as a component of construction equipment.

14. An apparatus comprising:
a base having a first plurality of openings around a circumference for affixing the base to a mounting surface and a second plurality of openings, the base further including a mounting portion on which a GPS unit and at least one antenna can be mounted; and
a top portion to cover the base so that the GPS unit is not visible, the top portion comprising a third plurality of openings for affixing the top portion to the base via the second plurality of openings, the top portion further comprising an outwardly extending opaque element positioned substantially over the GPS unit when the top portion is affixed to the base.

15. An apparatus as in claim 14 wherein the opaque element is cylindrical.

16. An apparatus as in claim 14, wherein at least one of the base and the top portion is made from a material through which the satellite signals from GPS satellites can propagate.

17. An apparatus as in claim 14, wherein the top portion completely covers the base when affixed thereto.

18. An apparatus as in claim 14, wherein the top portion further comprises a light element positioned to emit light through the opaque element.

19. An apparatus as in claim 18, wherein the base further comprises a light element positioned to emit light through the opaque element when the top portion is affixed to the base.

20. An apparatus as in claim 14, wherein the top portion comprises at least one port for coupling electrical connections to one or more devices enclosed by the top portion.
